(19) United States
(12) Patent Application Publication
(10) Pub. No.: US 2009/0140042 A1
(43) Pub. Date: Jun. 4, 2009

(54) Encased stored value card

(76) Inventor: Timothy Clegg, Manhattan Beach, CA (US)

Correspondence Address: LAW OFFICES OF CLEMENT CHENG, 17220 NEWHOPE STREET #127, FOUNTAIN VALLEY, CA, 92708, US

(21) Appl. No.: 11/999,142

(22) Filed: Dec. 4, 2007

(51) Int. Cl. G09F 19/00; G06K 19/04

(52) U.S. Cl. 235/380; 40/442; 40/455; 40/464

(57) ABSTRACT

An encased stored value card for decoratively presenting is provided comprising an electronic light and/or audio circuit with a switch and a lighting element and/or a speaker; and a housing for holding the electronic circuit permanently as well as the card removably. The housing may have different opening schemes including an upper shell and a lower shell joined by one or more hinge connections and a lock to allow the shells to swivel between a closed position where the upper shell mates with the lower shell temporarily and an open position for retrieval of the card. The electronic circuit is generally embedded in the housing but for the lighting element and speaker so that the lighting element is partially exposed through the housing and is configured to illuminate upon activation of the switch and at the same time the speaker propagates sound at perforations locally formed through the housing.

### BACKGROUND OF THE INVENTION

A. Field of the Invention

The present invention relates to stored-value cards. More particularly, the present invention relates to electronic multisensual cases for carrying and presenting credit or cash cards and the like.

B. Description of the Prior Art

The gift card is a consumer product that is favorable to both the retailer and the shopper. For the retailer, gift cards guarantee huge profit advantages each year. For the customer, gift cards make both shopping and gift giving easy. Gift cards can be small plastic cards that look like traditional credit cards. Like credit cards, gift cards may have a barcode or magnetic strip that is processed through a standard electronic credit card machine. They may be issued by credit card companies, retail stores, banks, restaurants, or other institutions. The gift card recipient uses the card as a form of currency to make purchases at the issuing company's locations.

Gift cards have no value until they are purchased and activated at checkout, which creates no significant financial loss for the retailer if the cards are stolen. The card obtains value only when the customer purchases the card or when the cashier enters the amount the customer wishes to place on the card. Gift cards can be purchased in stores and through catalogues. However, they can also be purchased online, in which case, an electronic gift card would be issued via email. Electronic gift cards allow gift recipients to receive the card instantly and also eliminates shipping and handling charges. Once purchased, the card's value is saved in the store's database which is then crosslinked to the card's ID. Gift cards are usually available in set amounts such as $25, $50, $100, $500. They could also be purchased for any random amount depending on the individual issuing company. For example, one could purchase a gift card for $32 for someone's $32nd birthday.

There is usually no extra or additional fees to purchase a gift card. However, some card providers charge maintenance fees on the cards which are absorbed by the card user.

Essentially, cards depreciate usually after 2 years from the date of purchase. Particularly, some card providers charge a small fee, e.g. $2.50 a month. Some cards expire after 2 years from the date of purchase. Increasingly, card providers are eliminating maintenance fees and expirations. Therefore, unused balances on the card remains until the card is spent. Most cards can be re-loaded after the balance on the card is spent.

Traditionally, gift cards can be redeemed only at the issuing company. However, some companies are expanding their business by seeking the multi-channel route in the form of a segmented gift card. This type of card allows one to use the card at a number of unrelated retailers, thereby reducing the number of cards one has to carry around. Gift cards issued by credit card companies like VISA, MasterCard and American Express also function in a similar fashion. For example, a VISA gift card can be redeemed at any location where a VISA credit card is accepted.

Accessorizing cards such as stored-value gift cards and other financial transactions cards are disclosed in a wide variety of patents and patent applications. For example, U.S. Pat. No. 7,234,639 and application Ser. No.: 11/038,018 filed Jan. 18, 2005 under Stored-Value Card with Light; Ser. No. 11/038,011 filed Jan. 18, 2005 under Stored-Value Card with Sound and Light; Ser. No. 11/037,385 filed Jan. 18, 2005 under Stored-Value Card with Sound; Ser. No. 11/404,367 filed Apr. 14, 2006 under Stored-Value Card with Bubble Wand; Ser. No. 11/404,584 filed Apr. 14, 2006 under Stored-Value Card with Housed Object; Ser. No. 11/437,462 filed May 19, 2006 under Stored-Value Card with Manufactured Article; Ser. No. 11/510,264 filed Aug. 25, 2006 under Stored-Value Card with Chemical Luminescence; Ser. No. 11/592,713 filed Nov. 3, 2006 under Inflatable Financial Transaction Product; Ser. No. 11/592,759 filed Nov. 3, 2006 under Financial Transaction Card Assembly with Packaged Goods; Ser. No. 11/604,016 filed Nov. 22, 2006 under Financial Transaction Product with Media Player; Ser. No. 11/645,143 filed Dec. 22, 2006 under Transactional Card with Visual Effect; Ser. No. 11/615,861 filed Dec. 22, 2006 under Financial Transaction Card with Pop-Up Member; Ser. No. 11/592,760 filed Jan. 11, 2007 under Financial Transactional Card with Storage Chamber; Ser. No. 11/687,280 filed Mar. 16, 2007 under Stored-Value Pedometer and Clip; Ser. No. 11/697,271 filed Apr. 5, 2007 under Stored-Value Product with Housed Article; Ser. No. 11/697,462 filed Apr. 6, 2007 under Transaction Card with Beads; Ser. No. 11/753,854 filed May 25, 2007 under Mechanically Convertible Transaction Product; Ser. No. 11/843,855 filed Aug. 23, 2007 under Transaction Product with Gelatinous Substance; Ser. No. 11/843,844 filed Aug. 23, 2007 under Transaction Product with Removable Articles; and Ser. No. 11/843,856 filed Aug. 23, 2007 under Transaction Card with Sound and Transformative Playback Feature all provide for a wide variety of different features relating to a stored value card. These features include all kinds of modifications of a lighted and sound producing stored value card. The above-identified patent and applications are incorporated herein by reference. In some cases, the references show a good way of attracting a customers attention.

Stored-value cards and other financial transactions cards come in many forms. A gift card, for example, is a type of stored-value card that includes pre-loaded or selectively loaded monetary value. In one example, a customer buys a gift card having a specified value for presentation as a gift for another person. In another example, a customer is offered a gift card as an incentive to make a purchase. A gift card, like other stored-value cards, can be “recharged” or “reloaded” at the direction of the bearer. The balance associated with the card declines as the card is used, encouraging repeated visits to the retailer or other provider issuing the card. Additionally, the card generally remains in the user's purse or wallet, serving as an advertisement or reminder to revisit the associated retailer. Gift cards provide a number of advantages to both the consumer and the retailer.

For higher valued gift cards and such of this kind, there is also a need for an alternative way to deliver the respective multisensory enhancements in separate packages to retain the exact same material and feel of conventional plastic cards that can be dispensed from the associated package.

The main drawback of the ingenious gift cards has been having to imprint the account identifier on a front or back side of the gift card housing. In this manner, the gift card is difficult to disguise as a gift. Also, the account identifier is visible before purchase.

Therefore, an object of the present invention is to provide multisensory cases that maintain the extra enhancements associated with stored-values in card member while providing a secure temporary encasement of a broad range of existing commercial value cards.

Another object of the present invention is to provide multisensory cases that maintain the extra card enhancements while providing a decorative housing to hold the card member in an attractive and concealed manner.

Yet another object of the present invention is to provide durable card cases that maintain the extra card enhancements even after the card member is transferred to an owner's possession, when the case can be converted to a universal card case with its stored audio message or statement continues to reminiscent of the card issuer.

Yet another object of the present invention is to provide a reference foundation for making different case designs for stored-value cards that have various aesthetic and functional openings to fit diverse transactional needs.

Yet another object of the present invention is to provide a universal multisensory light/sound circuit module that combines with different case designs for cards.

### SUMMARY OF THE INVENTION

An encased stored value card for decoratively containing stored-value cards according to one embodiment of the present invention comprises: an electronic light and/or audio circuit with a switching means and a lighting element and/or a speaker; and a housing for holding the electronic circuit permanently as well as the card removably. The housing includes an upper shell and a lower shell joined by one or more hinge connections and a locking means to allow the shells to swivel between a closed position where the upper shell mates with the lower shell temporarily and an open position for retrieval of the card. The electronic circuit is generally embedded in the housing but for the lighting element and speaker so that the lighting element is partially exposed through the housing and is configured to illuminate upon activation of the switching means and at the same time the speaker propagates sound at perforations locally formed through the housing.

The upper shell may form a lid member having an underneath tray fixedly secured thereto for enclosing the electronic circuit and the lower shell has a seat member for holding the card at an elevated position for an easy retrieval. The upper shell is dimensioned to wrap around the lower shell along vertical peripheral walls formed on the lower shell and the locking means may be a slight protrusion toward the upper shell to have the closed position maintained until a manual force releases the upper shell over the protrusion. Alternatively, the upper shell may form a lid member having an integrally formed tray covered by an outer shell fixedly secured thereto for enclosing the electronic circuit and the lower shell may have floor surfaces contoured to seat the card at an elevated position for an easy retrieval. The upper shell and the lower shell may have a horizontal meeting face and the locking means may comprise an eyelet section integrally formed on the lower shell and a hook fastened to the upper shell to protrude resiliently into the eyelet until the hook is pushed away manually from the eyelet section. The upper shell may form a lid member coupled by the hinge connections to the lower shell forming a tray, the lid member including decorative indicia, wherein the decorative indicia depict the respective positions of the switching means, lighting element and speaker.

The electronic circuit in the lid member further includes a slide switch having a pair of contacts connected in parallel to the switching means and a tongue member having one end held slidable between the contacts to make and break the circuit and the opposite end attached to the tray close to its swivel connection with the lid member, whereby opening motion of the lid member automatically activates the electronic light and/or audio circuit to operate the lighting element and/or speaker. The slide switch may be is automatically activated by opening the case while the push switch is intentionally activated by a user depressing on the case opened or closed at a button indicator of the decorative indicia to illuminate the light and/or activate the speaker. The upper shell and the lower shell may be formed of a sheet metal and the tray of the upper shell lid member may be of a plastic. Alternatively, the upper shell and the lower shell may be formed of one piece plastic with an integral living hinge between them and the outer shell is formed of a second material fixed to the lid member. The upper shell may be in a first color and the lower shell in a second color. The housing includes a lighting aperture and a face panel that holds the decorative indicia of the switch, lighting element and speaker with an illumination of the lighting element being visible through the face panel at the lighting aperture.

An encased stored value card for decoratively containing stored-value cards according to another embodiment of the present invention comprises: an electronic light and/or audio circuit with a switch and a lighting element and/or a speaker; and a housing including a rectangular base having a bottom panel, a first pair of opposing side panels erected upright from the bottom panel, a second pair of opposing side panels that connect the first pair of panels and a circumferential overhang from the pairs of side panels to define a top rectangular opening in the center of the housing, which also includes two half lid sections joined to the base by two opposite hinge connections at the first or second pairs of side panels to allow the lid sections to swivel between a closed position where the lid sections are brought together at a flush meeting line where they are releasably locked onto the base and an open position for retrieval of the card. The base with a capacity to accommodate the electronic circuit has a tray insert shaped to fit into the top opening for enclosing the electronic circuit permanently and for holding the card at an elevated position for an easy retrieval. The respective hinge connections may comprise knuckle parts formed integral to the lid sections and pairs of short pintle members formed integral to the base extending through the lid sections into the knuckle parts.

The two lid sections extend flush when they are closed and have a locking means including a sliding latch mounted edgewise on one of the lid sections and a mating keeper formed on the other lid section for receiving the sliding latch of the opposite lid, and a pair of pull-tabs fastened to the latch and keeper respectively for disengaging the latch from the keeper while pivotally opening the lid sections. The two half lid sections are also adapted to swivel between a locked closed position where the lid sections are brought together at a flush meeting line on the base and a locked open position where the lid sections may be pivoted to reach below the level of the bottom panel of the base and locked to erect the base for displaying the card at an elevated position until it is retrieved by a card recipient.

According to another embodiment of the present invention, an encased stored value card for decoratively containing stored-value cards comprises: an electronic light and/or audio circuit with a switch and a lighting element and/or a speaker generally contained in a thin container but for the lighting element and speaker and being configured to be illuminated upon activation of the switch and at the same time propagates sound at perforations locally formed through the container; and a housing including a rectangular base having a bottom panel, a pair of elongated walls extending upwardly from two opposite edges of the bottom panel, a pair of opposing side shoulders that connect the two elongated walls and two opposite inner walls defining interior surfaces of the side shoulders to provide a top rectangular cavity in the housing. The housing also includes a lid panel extending to cover the top housing cavity, a pivoting tray affixed to the lid panel at its underside for holding the electronic circuit container permanently as well as the card temporarily, a slidingly movable hinge connection for joining the lid panel with tray pivotally to the interior surfaces of the side shoulders so that a manual opening of the lid panel moves the lid panel, tray, electronic circuit container and an optional card in unity about the hinge connection, which is guided to shift a predetermined distance along the interior surfaces of the side shoulders, thereby maintaining the card at a convenient position to observe and retrieve.

Yet another embodiment of the present invention provides an encased stored value card for decoratively containing stored-value cards comprising: an electronic light and/or audio circuit with a switch and a lighting element and/or a speaker generally contained in a thin container but for the lighting element and speaker and being configured to be illuminated upon activation of the switch and at the same time propagates sound at perforations locally formed through the container; and a housing including a rectangular base having a two tiered bottom panel with two parallel guide slots maintained at its opposite sides, a pair of slidable half dome sections mounted to slide along the guide slots of the bottom panel for enclosing an appropriate space above the base to hold the electronic circuit container when the dome sections are slidingly closed together. In addition, the housing includes a pivoting tray connected to the base for holding the electronic circuit container permanently as well as the card temporarily, a slidingly movable hinge connection for joining the tray with the base pivotally so that a manual sliding of the two dome sections away from each other permits the tray, electronic circuit container and an optional card pivot in unity about the hinge connection, thereby maintaining the card at a convenient position to observe and retrieve.

Embodiments of the invention will now be described by way of example with reference to the accompanying drawings.

### BRIEF DESCRIPTION OF THE DRAWINGS

FIG. 1 is a perspective view of a first embodiment of a multisensory case for stored-value card, according to the present invention.

FIG. 2 is a rear bottom perspective view of the multisensory card case of FIG. 1 to show the hinge connections, according to the present invention.

FIG. 3 is an exploded, top perspective view of a lid member of the multisensory card case of FIG. 1 showing the components of electronic circuit inside.

FIG. 4 is a perspective view of a second embodiment of a multisensory case for stored-value card, according to the present invention.

FIG. 5 is a top perspective view of the FIG. 4 multisensory card case closed.

FIG. 6 is a side view of the multisensory card case showing a slide tongue switching mechanism in two states of operation as applied to the second embodiment of the present invention.

FIG. 7 is a perspective view of a third embodiment of a multisensory case for stored-value card, according to the present invention.

FIG. 8 is a top perspective view of the FIG. 7 multisensory card case closed.

FIG. 9 is a perspective view of a fourth embodiment of a multisensory case for stored-value card in an open stance, according to the present invention.

FIG. 10 is a top perspective view of the FIG. 9 multisensory card case closed.

FIG. 11 is a partially exploded, perspective view of a fifth embodiment of a multisensory card case for stored-value card with an open lid, according to the present invention.

FIG. 12 is a top perspective view of the FIG. 11 multisensory card case closed.

FIG. 13 is a plan view of a sixth embodiment of a multisensory case for stored-value card with two slidable half-dome sections in fully open position, according to the present invention.

FIG. 14 is a front elevational view of the FIG. 13 multisensory card case.

FIG. 15 is a side elevational view of the FIG. 13 multisensory card case with the dome sections opened and a pivoting tray tilted up for an optional card to present.

Similar reference numbers denote corresponding features throughout the attached drawings.

### DETAILED DESCRIPTION OF THE PREFERRED EMBODIMENT

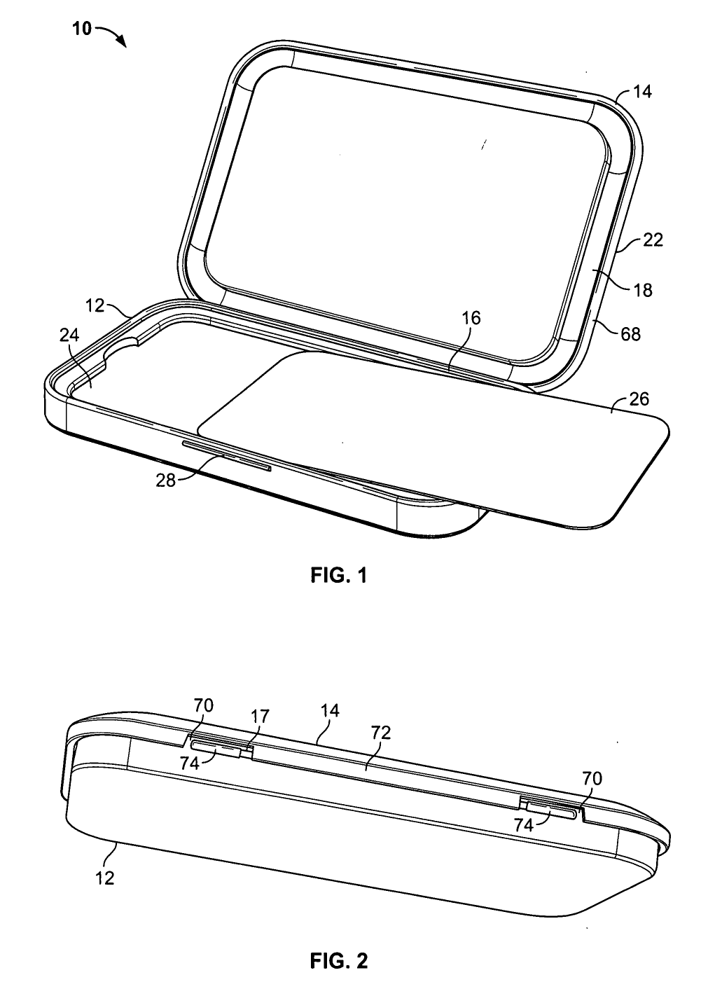

FIG. 1 shows a perspective view of a first embodiment of a multisensory case 10 for stored-value cards, according to the present invention. The case 10 may be made primarily of sheet metal such as tin, which is formed into a generally rectangular tray 12 and a slightly larger lid member 14 hinged to a longer side 16 of tray 12 by a pintle 17 threading directly through appropriate lateral holes formed on the tray 12 and lid member 14, as is clearly shown in FIG. 2. The tray 12 is simple compared to the lid member 14, which is consisted of an inner shell 18 deep drawn to have a rectangular center recess 20 and an outer shell 22 having its margins superimposed and rolled over the inner shell 18. The tray 12 may be lined with a raised foam seat 24 made by vacuum forming in order to hold a gift/credit card 26 snugly at its bottom and four lateral sides.

Therefore, there is formed a protected space in the recess 20 for holding a sound/light electronic assembly as disclosed in U.S. patent application Ser. No. 11/038,011. The lid member 14 is dimensioned to wrap around the tray 12 along vertical peripheral walls formed on the tray 12 and a locking means of a slight protrusion 28 is formed outwardly to keep the case 10 closed until a manual force releases the lid member 14 over the protrusion 28.

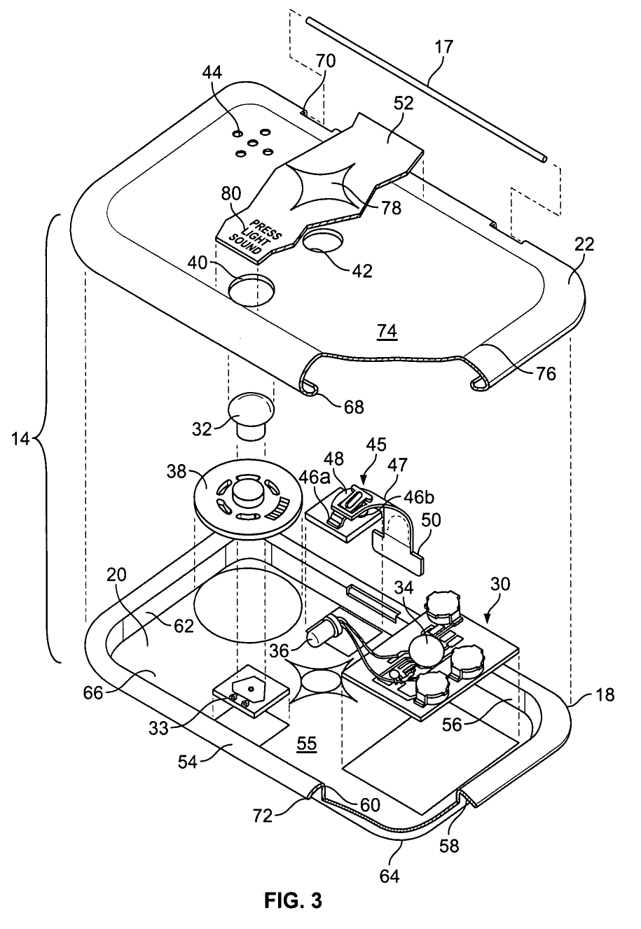

FIG. 3 illustrates an exploded, top perspective view of an electronic sound/light circuit 30 positioned in the lid member 14 according to the present invention. Lid member 14 houses electronic circuit 30 and a button 32 between its inner shell 18 and outer shell 22. Electronic circuit 30 stores an audio file at a microprocessor 34 and includes a light 36 and a speaker 38. Electronic circuit 30 is fixed to the bottom of recess 20 of inner shell 18 and outer shell 22 covers electronic circuit 30 except button 32 at a first hole 40, light 36 at a second hole 42 and speaker 38 at perforations 44. Button 32 is at least partially housed within lid member 14 and is configured to interact with electronic circuit 30. In particular, upon depression of button 32 by a user, electronic circuit 30 is activated through a push switch member 33 to illuminate light 36 and to play the audio file via speaker 38. The electronic circuit 30 in the lid member 14 further includes a slide switch 45 having a pair of contacts 46a and 46b connected in parallel to the switch member 33 and a tongue member 47 having one end 48 held slidable between the contacts 46a, 46b to make and break the circuit 30 and the opposite end 50 attached to the tray 12 close to its swivel connection at 17 with the lid member 14, whereby opening motion of the lid member 14 automatically activates the electronic light and/or audio circuit 30 to operate the lighting element 36 and/or speaker 38. The slide switch 45 is automatically activated by opening the case 10 while the push switch 33 is intentionally activated by the user depressing on the case 10 opened or closed at a button indicator 80 of the decorative indicia to illuminate the light 36 and/or activate the speaker 38.

Face panel 52 is optionally coupled to outer shell 22 to provide multisensory case 10 and its matching stored-value card 26 with indicia relating to one or more of an occasion, season, store identifier, brand identifier, media format indicia, e.g. characters, logos, scenes, or other illustrations or photographs relating to at least one of a movie, television show, book, video game, and a sport, etc.

Inner shell 18 of lid member 14 mounting the electronic circuit 30 resembles a tray having the recess 20 with a rectangular rim 54 that may extend outwardly and slightly downwardly. In one embodiment, of the two component shells inner shell 18 is a base for supporting electronic circuit 30, and outer shell 22 is a cover as shown in FIG. 1. Inner shell 18 generally includes a primary panel 55 and sidewalls 56, 58, 60, and 62. Inner shell 18 is generally planar in the middle and defines an outside surface 64 and an inside surface 66, which is opposite to outside surface 64 and permanently closed by outer shell 22 having an inwardly convoluted edge 68 that rides over rim 54 of inner shell 18 to clinch the same resulting in a unitary electronic lid member 14. FIG. 2 shows convoluted edge 68 generally extending about the peripheral end of outer shell 22 except two notches 70 formed on a rear side 72 of lid member 14 where integral knuckle portions 74 punched out from the tray 12. The hinge pintle 17 is inserted through convoluted edge 68 between notches 70 and then penetrated into opposing openings of knuckle portions 74 at its opposite ends.

In one embodiment, inner shell 18 resides in the lid member 14 and is generally rectangular and sized slightly larger than an identification card, a credit card, or other card sized to fit in a wallet of a user. In other embodiments, inner shell 18 resides in the tray 12 and may be otherwise shaped as a square, circle, oval, star, or any other suitable shape as long as it contains the electronic circuit 30.

Sidewalls 56, 58, 60, and 62 each extends upright and collectively extend generally about the entire perimeter of primary panel 55. In one embodiment, each sidewall 56, 58, 60, and 62 extends with a generally perpendicular orientation relative to primary panel 55. Rectangular rim 54 connects all of the four sidewalls 56, 58, 60, and 62 extending gradually downwardly to the level of primary panel 55 and terminating with a downturn edge 72. In one example, downturn edge 72 of inner shell 18 is pushed into the inward convolution of edge 68 of outer shell 22 to have a neat locking engagement between the two shells. In one embodiment, at least the outer shell 22 forms curved or chamfered corners around the edge 68.

Just as a conventional card of its kind, the gift/credit card 26 may include an account identifier such as a barcode, magnetic strip, a smart chip or other electronic device, a radio frequency identification device, or other suitable identifier readily readable by a point-of-sale terminal or other account access station or kiosk. The account identifier indicates a financial account or record to which stored-value card 26 is linked. The account or record of the monetary balance on stored-value card 26 optionally is maintained on a database, other electronic or manual record-keeping system, or, in the case of “smart” cards for example, on a chip or other electronics or devices on stored-value card 26 itself. Accordingly, by scanning the account identifier, a financial account or record linked to stored-value card 26 is identified and can subsequently be activated, have amounts debited therefrom, and/or have amounts added thereto. With the above in mind, the account identifier is one example of means for linking stored-value card 26 with a financial account or record.

Face panel 52 of case 10 may be planar and generally cover a flat top area 74 of outer shell 14. Panel 52 may be formed of paper, plastic, or other suitable material for printing and adhering to flat area 74 with a good flexibility to transfer manual depressions to the button 32 and brightness to pass light from the element 36. In one embodiment, face panel 52 is sized to fit within a panel indentation 76 of outer shell 22. On a surface of face panel 52 there may be prints of indicia such as a decorative indicium 78, brand indicium (not shown), and a button indicator 80. In one embodiment, decorative indicium 78 relate to a particular occasion or life event such as a wedding, new baby, graduation, holiday, season, etc., a particular character, brand identifier, media format identifier or other visual design to promote purchase of stored-value card 26. In one particular embodiment, decorative indicia 78 include a picture or a graphic representing a character of a particular media format.

Brand indicia identify a brand associated with stored-value card 26, such as identifying a product brand, an issuer brand, and other indicia readily associated with a product or store, etc. Indicia 78 and/or the brand indicia is an example of means for associating stored-value card 26 with at least one of a product, a brand, a store, a holiday, a season, an occasion, and media format indicia.

Button indicator 80 is positioned on face panel 52 to generally align with button 32 upon assembly. In this respect, button indicator 80 indicates an area or location of stored-value card 26 where the bearer, e.g. the customer or recipient, can be led to push case 10 to hear the stored audio file and illuminate light 36, as will be further described below. Other combinations or selections of indicia to be displayed on face panel 52 are also contemplated. In one embodiment, the outside surface of face panel 52 is printed and finished in any one of a variety of manners such as matte, gloss, textured, or other effect finish. In one embodiment, the finish chosen for the outside surface of panel 52 may be chosen to match the base color of case 10 or complements the indicia included on the panel 52.

In one embodiment, face panel 52 includes a plurality of speaker apertures (not shown) formed through face panel 52 and configured to generally align with at least a portion of speaker perforations 44 of outer shell 22 upon assembly of case 10. Thus, sound coming from electronic circuit 30 has a generally clear pathway through at least a portion of speaker perforations 44 of shell 22 and the speaker apertures of face panel 52.

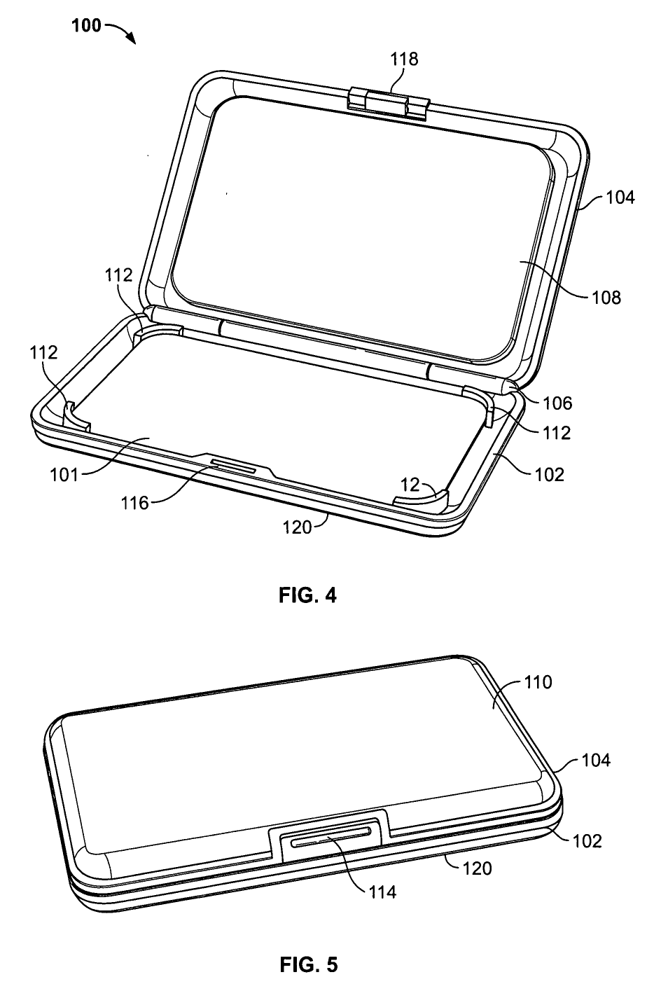

With reference to FIGS. 4 and 5 showing a second embodiment of the present invention, a multisensory case 100 for stored-value cards 101 comprises a tray 102 and a lid 104, both of which may be formed by injection molding of a plastic such as PVC or any other suitable material to define the various attributes of tray 102 and lid 104. In addition, a hinge 106 pivotally joins tray 102 and lid 104. The lid 104 has a deep recess 108 for the same electronic circuit 30 used with case 10 in the earlier embodiment.

Alternatively, tray 102 and lid 104 may be formed of a plastic with an integral living hinge between them and outer shells are separately formed of a second material and fixed to the lid as well as tray.

The lid 104 is covered by an outer shell 110 fixedly secured thereto for enclosing the electronic circuit 30 and the tray 102 has floor surfaces contoured to seat the card 100 at an elevated position for an easy retrieval. There may be four corner posts 112 integrally molded for this purpose. The tray 102 and bottom 104 may have a flat horizontal meeting surface and kept in a locking position by a locking means 114 that comprises an eyelet section 116 integrally formed on the tray 102 and a hook 118 fastened to the lid 104 to protrude resiliently into the eyelet 116 until the hook 118 is pushed away manually from the eyelet section 116.

To maintain a neat look, another outer shell 120 is attached to the exterior surface of the tray 102. The lid 104 may include the similar component holes formed in case 10 for the circuit 30 as well as decorative indicia on outer shell 110 which depict the respective positions of the switching means, lighting element and speaker of circuit 30. The tray 102 and lid 104 may be of the same color although it is simply a matter of design choice to use different colors.

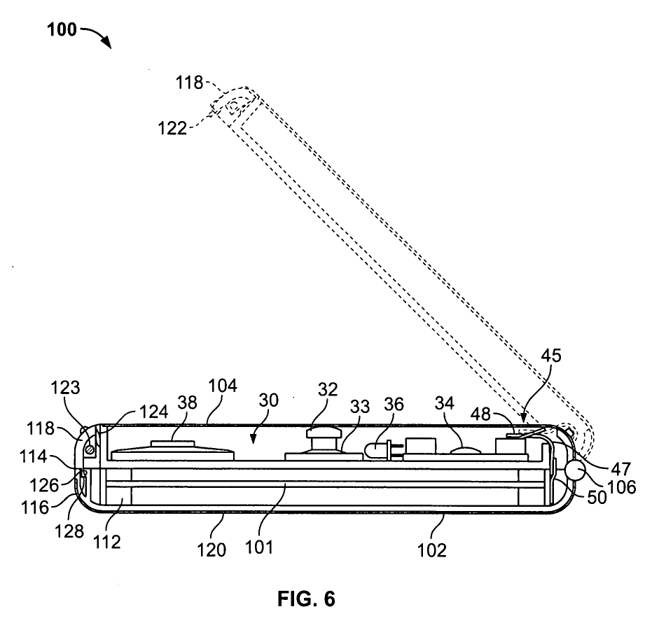

FIG. 6 clearly shows that case 100 also has the electronic circuit 30 in the lid 104 complete with slide switch 45 having tongue member 47 having one end 48 held slidable inside the lid 104 and the opposite end 50 attached to the tray 102 close to its swivel connection 106 with the lid member 104. Therefore, opening motion of the lid member 104 pulls the tongue member 47 and automatically activates the electronic light and/or audio circuit 30 to operate the lighting element 36 and/or speaker 38. The slide switch 45 is automatically activated by opening the case 100 while the push switch 33 is intentionally activated by the user depressing on the case 100 opened or closed at the corresponding button indicator of the decorative indicia to illuminate the light 36 and/or activate the speaker 38.

Also shown is the locking means 114 with hook 118, which has a lip 122 pivoting about an axis 123 and urged by a resilient extension 126 to engage a sill 128 formed on tray 102 inside the eyelet section 116.

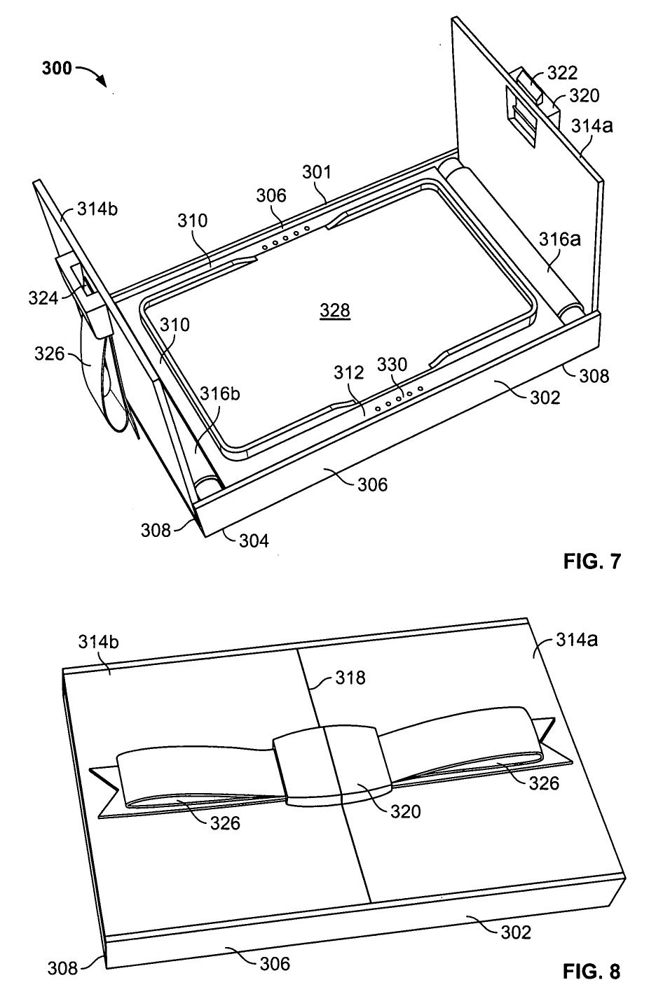

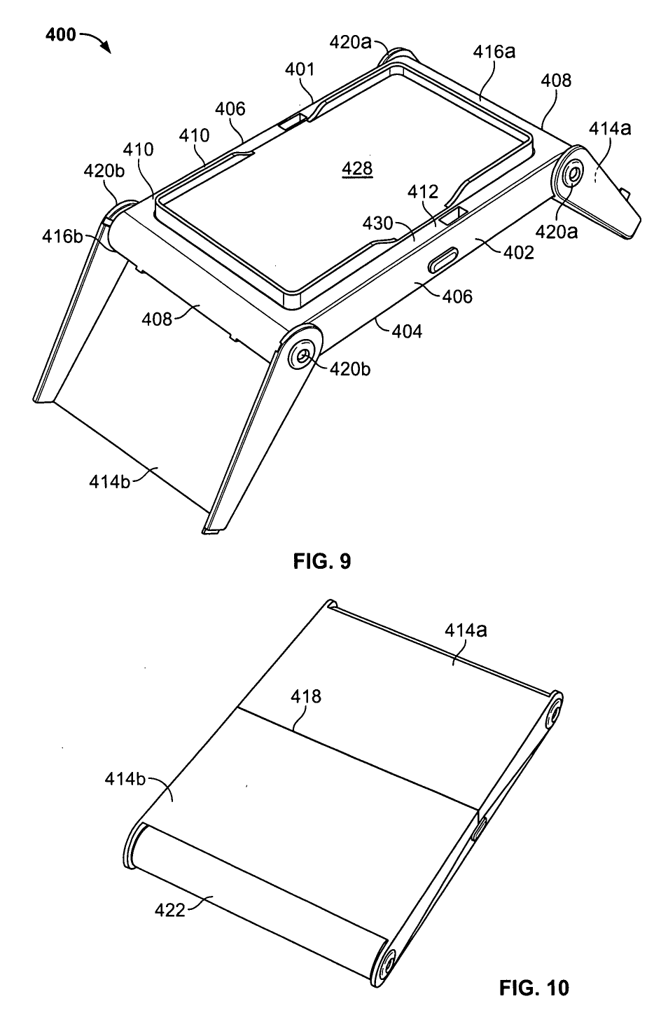

FIGS. 7 and 9 show a third embodiment of a multisensory case 300 of the present invention. In addition to the same construction of electronic circuit 30, case 300 comprises a housing 301 including a rectangular base 302 having a bottom panel 304, a first pair of opposing side panels 306 erected upright from the bottom panel 304, a second pair of opposing side panels 308 that connect the first pair of panels 306 and a circumferential overhang 310 from the pairs of side panels 306, 308 to define a top rectangular opening 312 in the center of the housing 301. Housing 301 also includes two half lid sections 314a and 314b joined to the base 302 by two hinge connections 316a and 316b at the second pairs of side panels 308 to allow the lid sections 314a, 314b to swivel between a closed position where the lid sections 314a, 314b are brought together at a flush meeting line 318 and are releasably locked onto the base 302 and an open position for retrieval of a card (not shown). The respective hinge connections 316a, 316b comprise knuckle parts formed integral to the lid sections 314a, 314b and pairs of short pintle members (not shown) that may be formed integral to knuckle parts or the base 302. The two lid sections 314a, 314b extend flush when they are closed and have a locking means 320 including a sliding latch 322 mounted edgewise on one of the lid sections such as 314a and normally urged toward the meeting line 318 with the other lid section 314b having a mating keeper 324 for receiving the sliding latch 322. In addition, the lid sections 314a, 314b have a pair of pull-tabs 326 fastened to the latch 322 and keeper 324 respectively for disengaging the latch 322 from the keeper 324 while pivotally opening the lid sections 314a, 314b. The pull-tabs 326 may be made to resemble a gift ribbon tie for suggesting the user to pull them to open the case 300.

The base 302 has a capacity to accommodate the electronic circuit 30. A tray insert 328 fits into the top opening 312 for enclosing the electronic circuit 30 permanently and for holding the card at an elevated position for an easy retrieval. Thus, the electronic circuit 30 may be generally embedded in the housing 301 but for the lighting element 36 and speaker 38 through holes 330 formed on the overhang 310 and the lighting element 36 is configured to be illuminated upon activation of the switch 33 appropriately positioned on one of the second pair of side panels 308. The lid sections 314a, 314b extend outwardly beyond the pivot points of hinge connections 316a and 316b and one of lid sections 314a, 314b can depress the switch 33 simply by the opening motion of the case 300. In addition, the switch 33 may be indicated by a decorative indicium on the lid section 314b for a manual activation of the light 36 and speaker 38 with or without opening the case 300.

FIGS. 9 and 10 show a fourth embodiment of a multisensory case 400 according to the present invention. Case 400 differs from case 300 of FIG. 7 in the way its lid sections 424a, 414b operate for a heightened level of presenting a card (not shown).

Case 400 has a housing 401 with a base 402 and two half-lid sections 414a, 414b adapted to cover an overhang 410 of the base 402. Base 402 has a bottom panel 404, a first pair of side panels 406 and a second pair of side panels 408 for supporting the lid sections 414a, 414b through hinge connections 416a, 416b to allow the lid sections 414a, 414b to swivel between a locked closed position where the lid sections 414a, 414b are brought together at a flush meeting line 418 on the base 402 and a locked open position where the lid sections 414a, 414b are pivoted to reach below the level of the bottom panel 404 of the base 402 to suspend the base 402 for displaying the card at an elevated position until it is retrieved by a card recipient.

The two lid sections 416a, 416b extend flush when they are swiveled into closure about the hinge connections 416a, 416b each having a knuckle part formed internally of side panel 408 of the base 402, a couple of rivets 420a-420a or 420b-420b threading the lid section 414a, 414b and the knuckle parts in aligned but opposite directions so that the rivets 420 corotate with the lid sections 414a, 414b with respect to the knuckle parts. In addition, the lid sections 414a, 414b have a locking means (not shown) including eccentric levers located interior of the base 402 and fixed to distal ends of at least two adjacent parallel rivets 420a, 420b and a long spring member adapted to link the eccentric levers to pull the lid sections 414a, 414b normally toward each other, whereby a user swivels the lid sections 414a, 414b toward the fully open position under increasing resistance of the spring member to its threshold dead point, which must be overcome when the lid sections 414a, 414b are swiveled from the closed position to the open position and vice versa.

Switch 33 may be appropriately positioned to protrude from one of the side panels 408 such as at 422 near the border of bottom panel 404 and side panel 408 to permit a lid action switching by lid section 414b as well as a manual depression by the user. To this end, the location switch 33 may be indicated by a decorative indicium on the lid section 414b for a manual activation of the light 36 and speaker 38 with or without opening the case 400.

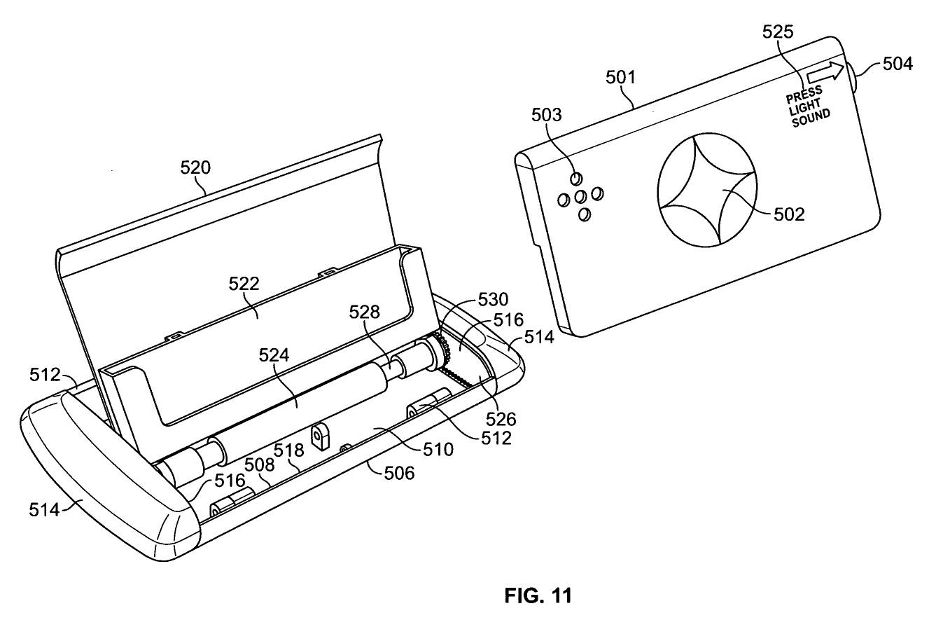

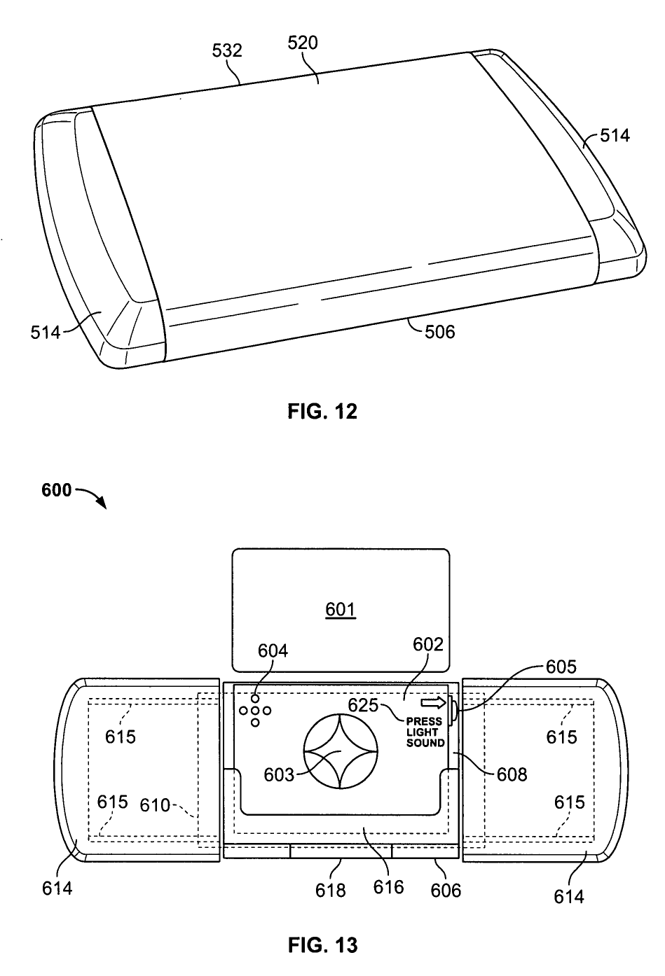

FIGS. 11 and 12 illustrates a fifth embodiment of a multisensory card 500 of the present invention wherein electronic light and/or audio circuit 30 is separately prepared with the similar switch 33 and a lighting element 36 and/or a speaker 38 generally contained in a thin container 501 but for the lighting element 36 at an indicium 502 and speaker 38 at holes 503 and being configured to be illuminated upon activation of the switch 33 at a side button 504.

Card case 500 comprises a housing 506 including a rectangular base 508 having a bottom panel 510, a pair of elongated walls 512 extending upwardly from two opposite edges of the bottom panel 510, a pair of opposing side shoulders 514 that connect the two elongated walls 512 and two opposite inner walls 516 defining interior surfaces of the side shoulders 514 to provide a top rectangular cavity 518 in the housing 506. The housing 506 also includes a lid panel 520 extending to cover the top housing cavity 518, a pivoting tray 522 affixed to the lid panel 520 at its underside for holding the electronic circuit container 501 permanently as well as a card (not shown) temporarily, a slidingly movable hinge connection 524 for joining the lid panel 520 with tray 522 pivotally to the interior surfaces 516 of the side shoulders 514 so that a manual opening of the lid panel 520 moves the lid panel 520, tray 522, electronic circuit container 501 and an optional card in unity about the hinge connection 524, which is guided to shift a predetermined distance along the interior surfaces 516 of the side shoulders 514, thereby maintaining the card at a convenient position to observe and retrieve.

The electronic circuit container 501 includes a decorative indicium for the switch 33 which can be manually as well as automatically activated by the initial pivot action of the tray 522. Upon installation of electronic circuit container 501 switch 33 at side button may be appropriately positioned to protrude from the lid panel 520 facing the side shoulder 514 to permit a lid action switching by lid panel 520 as well as a manual depression by the user. A decorative indicium 525 on the electronic circuit container 501 may be an indicator for the manual activation switch 33 to energize the light 36 and speaker 38.

The side shoulders 514 of the base 506 have toothed racks 526 extending along cross lines of the shoulders 514 with the base 506. The hinge connection 524 is affixed externally to the pivoting tray 522 and has two opposite end pins 528 with two freely rotatable pinion gears 530 adapted to mesh with the toothed racks 526 of the shoulders 514 in order to provide a stable parallel shift of the card in tray 522. In it fully open tilted position shown in FIG. 11, lid panel 520 bears the full load at its rear end 532 against the bottom panel 510.

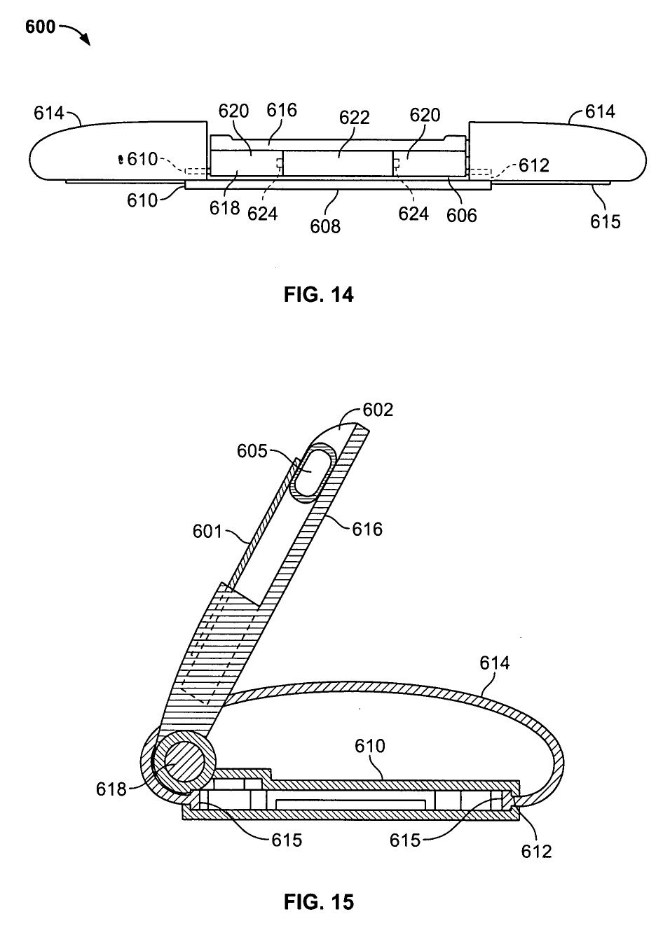

FIGS. 13 and 14 show a sixth embodiment of a multisensory case 600 for stored-value card 601 in its initial deployment stage and FIG. 15 shows the full presentation mode thereof.

The electronic light and/or audio circuit 30 is also separately prepared in this embodiment with the similar switch 33 and a lighting element 36 and/or a speaker 38 generally contained in a thin container 602 but for the lighting element 36 at an indicium 603 and speaker 38 at holes 604 and being configured to be illuminated upon activation of the switch 33 at a side button 605.

Card case 600 comprises a housing 606 including a rectangular base 608 having a two tiered bottom panel 610 with two parallel guide slots 612 maintained at its opposite sides, a pair of slidable half dome sections 614 each having two parallel upright edges 615 mounted to slide along the guide slots 612 of the bottom panel 610 for enclosing an appropriate space above the base 608 to hold the electronic circuit container 602 when the dome sections 614 are slidingly closed together, a pivoting tray 616 connected to the base 608 for holding the electronic circuit container 602 permanently as well as the card 601 temporarily, and a hinge connection 618 for joining the tray 616 with the base 608 pivotally so that a manual sliding of the two dome sections 614 away from each other permits the tray 616, electronic circuit container 602 and the optional card 601 pivot in unity about the hinge connection 618. Case 600 opens first with a sliding manipulation with dome sections 614 which is enough to retrieve the card 601. Optionally, the distinctive tilting of tray 616 may follow to maintain the card 601 at a convenient position to display and retrieve.

Alternatively, the subsequent tilting of tray 616 may be automatic with the assistance of a lift bias utilizing a spring member between the bottom panel 610 and tray 616, whereby the switching side button 605 is also triggered.

The electronic circuit container 602 includes a decorative indicium for the switch 33 which can be manually as well as automatically activated by the pivot action of the tray 616. Upon installation of electronic circuit container 602, switch 33 at side button 605 can be appropriately positioned to protrude from the tray 616 facing a sidewall of dome section 614 to permit a swivel action switching by tray 616 as well as a manual depression by the user. A decorative indicium 625 on the electronic circuit container 601 may be an indicator for the manual activation of switch 33 to power the light 36 and speaker 38.

The hinge connection 618 may comprise two end knuckle parts 620 formed in one piece affixed to the bottom panel 610, a cooperating middle knuckle piece 622 formed integral to the pivoting tray 616 and a pair of short pintle members 624 extending from the opposite ends of the middle knuckle piece 622 concentrically.

Therefore, while the presently preferred form of the electronic card cases have been shown and described, and several modifications thereof discussed, persons skilled in this art will readily appreciate that various additional changes and modifications may be made without departing from the spirit of the invention, as defined and differentiated by the following claims.

1. An encased stored value card comprising: an electronic light and/or audio circuit with a switch and a lighting element and/or a speaker; and a housing for holding the electronic circuit permanently as well as the card removably, the housing including an upper shell and a lower shell joined by one or more hinge connections and a lock to allow the shells to swivel between a closed position where the upper shell mates with the lower shell temporarily and an open position for retrieval of the card, wherein the electronic circuit being generally embedded in the housing but for the lighting element and speaker, wherein the lighting element is partially exposed through the housing and is configured to be illuminated upon activation of the switch and at the same time the speaker propagates sound at perforations locally formed through the housing.

2. The encased stored value card of claim 1, wherein the upper shell forms a lid member having an underneath tray fixedly secured thereto for enclosing the electronic circuit and the lower shell has a seat member for holding the card at an elevated position for an easy retrieval.

3. The encased stored value card of claim 2, wherein the upper shell is dimensioned to wrap around the lower shell along vertical peripheral walls formed on the lower shell and the lock is a slight protrusion toward the upper shell to have the closed position maintained until a manual force releases the upper shell over the protrusion.

4. The encased stored value card of claim 1, wherein the upper shell forms a lid member having an integrally formed tray covered by an outer shell fixedly secured thereto for enclosing the electronic circuit and the lower shell has floor surfaces contoured to seat the card at an elevated position for an easy retrieval.

5. The encased stored value card of claim 4, wherein the upper shell and the lower shell have a horizontal meeting surface and the lock comprises an eyelet section integrally formed on the lower shell and a hook fastened to the upper shell to protrude resiliently into the eyelet until the hook is pushed away manually from the eyelet section.

6. The encased stored value card of claim 1, wherein the upper shell forms a lid member coupled by the hinge connections to the lower shell forming a tray, the lid member including decorative indicia, wherein the decorative indicia depict the respective positions of the switch, lighting element and speaker.

7. The encased stored value card of claim 6, wherein the electronic circuit in the lid member further includes a slide switch having a pair of contacts connected in parallel to the switch and a tongue member having one end held slidable between the contacts to make and break the circuit and the opposite end attached to the tray close to its swivel connection with the lid member, whereby opening motion of the lid member automatically activates the electronic light and/or audio circuit to operate the lighting element and/or speaker.

8. The encased stored value card of claim 7, wherein the slide switch is automatically activated by opening the case while the push switch is intentionally activated by a user depressing on the case opened or closed at a button indicator of the decorative indicia to illuminate the light and/or activate the speaker.

9. The encased stored value card of claim 2, wherein the upper shell and the lower shell are formed of a sheet metal and the tray of the upper shell lid member is of a plastic.

10. The encased stored value card of claim 4, wherein the upper shell and the lower shell are formed of a plastic with an integral living hinge between them and the outer shell is formed of a second material fixed to the lid member.

11. The encased stored value card of claim 1, wherein the upper shell is in a first color and the lower shell is in a second color.

12. The encased stored value card of claim 1, wherein the housing includes a lighting aperture and a face panel that holds the decorative indicia of the switch, lighting element and speaker, and further wherein illumination of the lighting element is visible through the face panel at the lighting aperture.

13. An encased stored value card for decoratively containing stored-value cards comprising: an electronic light and/or audio circuit with a switch and a lighting element and/or a speaker; and a housing including a rectangular base having a bottom panel, a first pair of opposing side panels erected upright from the bottom panel, a second pair of opposing side panels that connect the first pair of panels and a circumferential overhang from the pairs of side panels to define a top rectangular opening in the center of the housing, which also includes two half lid sections joined to the base by two hinge connections at the first or second pairs of side panels to allow the lid sections to swivel between a closed position where the lid sections are brought together at a flush meeting line where they are releasably locked onto the base and an open position for retrieval of the card, wherein the base has a capacity to accommodate the electronic circuit, a tray insert fit into the top opening for enclosing the electronic circuit permanently and for holding the card at an elevated position for an easy retrieval, and wherein the electronic circuit is generally embedded in the housing but for the lighting element and speaker and is configured to be illuminated upon activation of the switch and at the same time propagates sound at perforations locally formed through the housing.

14. The encased stored value card of claim 13, wherein at least one of the side surfaces of the base includes a decorative indicium for the switch which can be manually activated and the two lid sections are swivably coupled to the base at shifted positions toward the meeting line of the lid sections so that the lid sections extend slightly beyond the hinge connections respectively to depress the switch as the lid sections swivel to the open position to reveal the card and automatically start the electronic light and/or audio circuit.

15. The encased stored value card of claim 13, wherein the respective hinge connections comprise knuckle parts formed integral to the lid sections and pairs of short pintle members formed integral to the base extending through the lid sections into the knuckle parts.

16. The encased stored value card of claim 13, wherein the two lid sections extend flush when they are closed and have a lock including a sliding latch mounted edgewise on one of the lid sections and normally urged toward the meeting line with the other lid section, a mating keeper formed on the other lid section for receiving the sliding latch of the opposite lid, and a pair of pull-tabs fastened to the latch and keeper respectively for disengaging the latch from the keeper while pivotally opening the lid sections.

17. The encased stored value card of claim 16, wherein the pull-tabs resemble a gift ribbon tie for suggesting the user to pull them to open the case.

18. The encased stored value card of claim 17, wherein the lid sections and tray insert are in a first color and the pull-tabs are in a second color.

19. The encased stored value card of claim 13, wherein the housing includes a light aperture and holds the decorative indicia of the switch, light element and speaker, and further wherein illumination of the lighting element is visible through the housing at the light aperture.

20. The encased stored value card of claim 13, wherein the two half lid sections are adapted to cover the overhang of the base and its second pair of side panels with the first pair of side panels supporting the lid sections through the hinge connections to allow the lid sections to swivel between a locked closed position where the lid sections are brought together at a flush meeting line on the base and a locked open position where the lid sections are pivoted to reach below the level of the bottom panel of the base to suspend the base for displaying the card at an elevated position until it is retrieved by a card recipient.

21. The encased stored value card of claim 20, wherein the two lid sections extend flush when they are swiveled into closure about the hinge connections each having a knuckle part formed integral to the base, a couple of rivets threading the lid section and the knuckle parts in aligned but opposite directions so that the rivets corotate with the lid sections with respect to the knuckle parts, the lid sections having a lock including eccentric levers located interior of the base and fixed to distal ends of at least two adjacent parallel rivets and a long spring member adapted to link the eccentric levers to pull the lid sections normally toward each other, whereby a user swivels the lid sections toward the fully open position under increasing resistance of the spring member to its threshold dead point, which must be overcome when the lid sections are swiveled from the closed position to the open position and vice versa.

22. An encased stored value card for decoratively containing stored-value cards comprising: an electronic light and/or audio circuit with a switch and a lighting element and/or a speaker generally contained in a thin container but for the lighting element and speaker and being configured to be illuminated upon activation of the switch and at the same time propagates sound at perforations locally formed through the container; and a housing including a rectangular base having a bottom panel, a pair of elongated walls extending upwardly from two opposite edges of the bottom panel, a pair of opposing side shoulders that connect the two elongated walls and two opposite inner walls defining interior surfaces of the side shoulders to provide a top rectangular cavity in the housing, which also includes a lid panel extending to cover the top housing cavity, a pivoting tray affixed to the lid panel at its underside for holding the electronic circuit container permanently as well as the card temporarily, a slidingly movable hinge connection for joining the lid panel with tray pivotally to the interior surfaces of the side shoulders so that a manual opening of the lid panel moves the lid panel, tray, electronic circuit container and an optional card in unity about the hinge connection, which is guided to shift a predetermined distance along the interior surfaces of the side shoulders, thereby maintaining the card at a convenient position to observe and retrieve.

23. The encased stored value card of claim 22, wherein the electronic circuit container includes a decorative indicium for the switch which can be manually as well as automatically activated by the initial pivot action of the tray and the side shoulders of the base having toothed racks extending along cross lines of the shoulders with the base and the hinge connection being affixed externally to the pivoting tray and having two opposite end pins with two freely rotatable pinion gears adapted to mesh with the toothed racks of the shoulders in order to provide a stable parallel shift of the card in tray.

24. The encased stored value card of claim 22, wherein the lid panel is in a first color and the side shoulder is in a second color.

25. The encased stored value card of claim 22, wherein the electronic circuit container includes a light aperture and holds the decorative indicia of the switch, light element and speaker, and further wherein illumination of the lighting element is visible through the electronic circuit container at the light aperture.

26. An encased stored value card for decoratively containing stored-value cards comprising: an electronic light and/or audio circuit with a switch and a lighting element and/or a speaker generally contained in a thin container but for the lighting element and speaker and being configured to be illuminated upon activation of the switch and at the same time propagates sound at perforations locally formed through the container; and a housing including a rectangular base having a two tiered bottom panel with two parallel guide slots maintained at its opposite sides, a pair of slidable half dome sections each having two parallel upright edges mounted to slide along the guide slots of the bottom panel for enclosing an appropriate space above the base to hold the electronic circuit container when the dome sections are slidingly closed together, a pivoting tray connected to the base for holding the electronic circuit container permanently as well as the card temporarily, a hinge connection for joining the tray with the base pivotally so that a manual sliding of the two dome sections away from each other permits the tray, electronic circuit container and an optional card pivot in unity about the hinge connection, thereby maintaining the card at a convenient position to observe and retrieve.

27. The encased stored value card of claim 26, wherein the hinge connection comprises two end knuckle parts formed in one piece affixed to the bottom panel, a cooperating middle knuckle piece formed integral to the pivoting tray and a pair of short pintle members extending from the opposite ends of the middle knuckle piece concentrically.

28. The encased stored value card of claim 26, wherein the slidable dome sections are in a first color and the pivoting tray is in a second color.

29. The encased stored value card of claim 26, wherein the electronic circuit container includes a light aperture and holds the decorative indicia of the switch, light element and speaker, and further wherein illumination of the lighting element is visible through the electronic circuit container at the light aperture.
